(19) United States
(12) Patent Application Publication
(10) Pub. No.: US 2020/0012832 A1
(43) Pub. Date: Jan. 9, 2020

(54) LIGHT RECEIVING STACKED-HOLE STRUCTURE AND FABRICATION METHOD THEREOF, AND FINGERPRINT RECOGNITION DEVICE

(71) Applicant: BOE TECHNOLOGY GROUP CO., LTD., Beijing (CN)

(72) Inventors: Yang YUE, Beijing (CN); Shi SHU, Beijing (CN); Chuanxiang XU, Beijing (CN); Jiangnan LU, Beijing (CN); Haitao HUANG, Beijing (CN)

(73) Assignee: BOE TECHNOLOGY GROUP CO., LTD.

(21) Appl. No.: 16/441,687

(22) Filed: Jun. 14, 2019

(30) Foreign Application Priority Data
Jul. 6, 2018 (CN) 201810737587.2

(51) Int. Cl. G06K 9/00

(52) U.S. Cl. CPC G06K 9/0004; G06F 3/041

(57) ABSTRACT

The present disclosure provides a light receiving stacked-hole structure and a fabrication method thereof, and a fingerprint recognition device. The method includes forming a base light blocking layer having a first opening on a first surface of a substrate; forming at least one overlying light blocking layer having a second opening on a side of the base light blocking layer away from the substrate, wherein the overlying light blocking layer having the second opening is formed by using the base light blocking layer as a mask plate.

### CROSS-REFERENCE TO RELATED APPLICATION

This application claims the benefit of Chinese Patent Application No. 201810737587.2, filed on Jul. 6, 2018, the contents of which are incorporated herein in their entirety by reference.

### TECHNICAL FIELD

The present disclosure belongs to the field of fingerprint recognition technology, and in particular, relates to a light receiving stacked-hole structure and a fabrication method thereof, and a fingerprint recognition device.

### BACKGROUND

Fingerprint is an inherent characteristic of a human body which can be distinguished from that of others, and consists of a series of ridges and valleys on surfaces of skins of finger pads. A pattern formed by the ridges and valleys determines the uniqueness of the fingerprint. With the rapid development of the display technology, a display panel with fingerprint recognition function has gradually spread throughout people's lives.

### SUMMARY

In an aspect, the present disclosure provides a fabrication method of a light receiving stacked-hole structure, including:

forming a base light blocking layer having a first opening on a first surface of a substrate; and

forming at least one overlying light blocking layer having a second opening on a side of the base light blocking layer away from the substrate,

wherein forming the overlying light blocking layer having the second opening includes:

forming a light-transmissive defining layer on the side of the base light blocking layer away from the substrate and the first surface of the substrate;

patterning the defining layer by using the base light blocking layer as a mask plate to obtain a defining member, an orthographic projection of the defining member on the substrate coinciding with an orthographic projection of the first opening on the substrate; and

forming the overlying light blocking layer by using the defining member as a boundary thereof, the second opening of the overlying light blocking layer being filled with the defining member.

According to an embodiment of the present disclosure, in patterning the defining layer by using the base light blocking layer as a mask plate to obtain the defining member, the defining layer is exposed by light entering from a second surface of the substrate opposite to the first surface.

According to an embodiment of the present disclosure, the method includes forming a plurality of overlying light blocking layers having the second openings; and further includes forming a transparent material layer between forming adjacent two overlying light blocking layers having the second openings.

According to an embodiment of the present disclosure, the method further includes forming a transparent material layer between forming the base blocking layer having the first opening and forming the overlying light blocking layer having the second opening.

According to an embodiment of the present disclosure, the method further includes filling the first opening with the defining member between forming the base blocking layer having the first opening and forming the transparent material layer.

According to an embodiment of the present disclosure, the method further includes forming a transparent material layer on the first surface of the substrate before forming the base blocking layer having the first opening, and the base blocking layer having the first opening is formed on a side of the transparent material layer away from the substrate.

According to an embodiment of the present disclosure, material of the transparent material layer includes at least one of polyimide, over coat material, high transparent resin material, and transparent post spacer material.

In another aspect, the present disclosure provides a light receiving stacked-hole structure including:

a substrate;

a base light blocking layer disposed on a first surface of the substrate and having a first opening;

at least one overlying light blocking layer disposed on a side of the base light blocking layer away from the substrate and having a second opening filed with a light-transmissive defining member,

wherein the defining member is formed by using the base light blocking layer as a mask plate, and an orthographic projection of the defining member on the substrate coincides with an orthographic projection of the first opening on the substrate.

According to an embodiment of the present disclosure, the light receiving stacked-hole structure further includes a transparent material layer disposed between the overlying light blocking layer and the base light blocking layer and in the first opening of the base light blocking layer.

According to an embodiment of the present disclosure, the light receiving stacked-hole structure further includes a transparent material layer disposed between the overlying light blocking layer and the base light blocking layer, and the first opening of the base light blocking layer is filled with the light-transmissive defining member.

According to an embodiment of the present disclosure, the light receiving stacked-hole structure further includes a transparent material layer disposed between the substrate and the base light blocking layer.

According to an embodiment of the present disclosure, the light receiving stacked-hole structure includes a plurality of overlying light blocking layers, and a transparent material layer is disposed between adjacent two overlying light blocking layers.

According to an embodiment of the present disclosure, the light receiving stacked-hole structure has a size of about 70 μm to about 120 μm in a direction perpendicular to the first surface of the substrate, and each transparent material layer has a thickness of about 15 μm to about 35 μm.

According to an embodiment of the present disclosure, the defining member is made of a transparent organic material.

According to an embodiment of the present disclosure, material of the transparent material layer includes at least one of polyimide, over coat material, high transparent resin material, and transparent post spacer material.

In another aspect, the present disclosure provides a fingerprint recognition device, including:

a touch substrate, a back plate having a plurality of fingerprint recognition sensors, and a light receiving stacked-hole structure disposed between the touch substrate and the back plate, wherein the light receiving stacked-hole structure is the light receiving stacked-hole structure according to the embodiments of the present disclosure.

### BRIEF DESCRIPTION OF THE DRAWINGS

FIG. 1 is a schematic structural diagram of a conventional fingerprint recognition device;

FIG. 2 is a schematic diagram of an optical structural layer of a conventional fingerprint recognition device;

FIG. 3 is a schematic diagram illustrating a fabrication method of a light receiving stacked-hole structure according to an embodiment of the present disclosure;

FIG. 4 is a schematic diagram illustrating fabrication method of a light receiving stacked-hole structure according to another embodiment of the present disclosure;

FIG. 5 is a schematic structural diagram of a light receiving stacked-hole structure according to an embodiment of the present disclosure;

FIG. 6 is another schematic structural diagram of a light receiving stacked-hole structure according to an embodiment of the present disclosure;

FIG. 7 is still another schematic structural diagram of a light receiving stacked-hole structure according to an embodiment of the present disclosure; and

FIG. 8 is a schematic diagram of a fingerprint recognition device according to an embodiment of the present disclosure.

### DETAILED DESCRIPTION

The present disclosure will be further described in detail below in conjunction with the drawings and specific embodiments, in order to make those skilled in the art better understand the technical solutions of the present disclosure.

As shown in FIG. 1, a fingerprint recognition component is attached to at least part of a region under a touch substrate 11 of a display panel. The fingerprint recognition component includes a plurality of sensors 12. In operation, different sensors 12 receive light reflected by valleys and ridges of the user's fingerprint 13 and scan and analyze the light to recognize a fingerprint pattern formed by the valleys and ridges.

In the fingerprint recognition, in order to prevent a sensor 12 from receiving fingerprint information at fingerprint far from the sensor 12 to result in disordered or interfering fingerprint information received by the sensor 12, an optical structure layer 14 is generally additionally provided between the touch substrate 11 and the sensors 12 to remove stray light and thereby achieve accurate fingerprint recognition. The optical structure layer 14 may be a light blocking layer 15 made of a light blocking material and having a plurality of through holes. Since it is difficult to form the through holes penetrating through the light blocking material and having a specified depth by directly using current etching process, a solution in which a plurality of thin light blocking layers 15 are stacked to form a hole 16 consisting of a plurality of holes stacked on one another (hereinafter also referred to as a stacked-hole structure) is generally adopted.

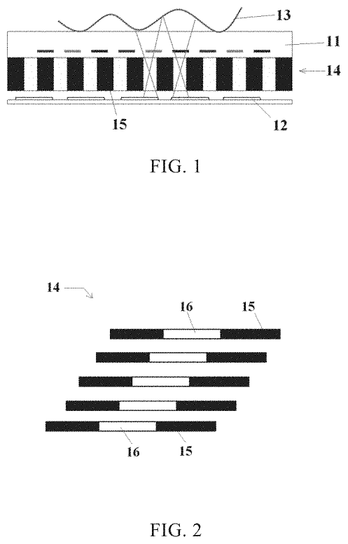

As shown in FIG. 2, in the fabrication process of the stacked-hole structure 16, an etching process is required to be performed multiple times, and due to the limited condition of the etching process, the stacked-hole structure 16 has a low alignment precision and misalignment is likely to occur, which results in that the stacked-hole structure 16 obtained by the multiple etching processes cannot form a normal light path. Therefore, the sensor 12 is unable to perform normal fingerprint recognition.

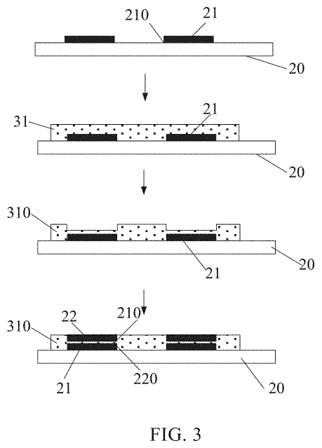

An embodiment of the present embodiment provides a fabrication method of a light receiving stacked-hole structure, as shown in FIG. 3, including the following fabrication step S1 and step S2.

Step S1 includes forming a base light blocking layer 21 having a first opening 210 on a first surface of a substrate 20.

Step S2 includes forming a overlying light blocking layer 22 having a second opening 220 on the substrate 20 subjected to the previous step (i.e., on the first surface of the substrate 20 and a side of the base light blocking layer 21 away from the substrate 20). An orthographic projection of the second opening 220 on the substrate 20 coincides with an orthographic projection of the first opening 210 on the substrate 20, such that the first opening 210 and the second opening 220 form a light receiving hole

According to an embodiment of the present disclosure, the base light blocking layer 21 and the overlying light blocking layer 22 may be formed of a light blocking material.

In an embodiment, step S2 of forming the overlying light blocking layer 22 having the second opening 220 includes step S2a to step S2c.

Step S2a includes forming a light-transmissive defining layer 31 on the first surface of the substrate 20 and the side of the base light blocking layer 21 away from the substrate 20

Step S2b includes patterning the defining layer 31 by using the base light blocking layer 21 as a mask plate to obtain a defining member 310, such that an orthographic projection of the defining member 310 on the substrate 20 coincides with an orthographic projection of the first opening 210 on the substrate 20.

Step S2c includes forming an overlying light blocking layer 22 by using the defining member 310 as a boundary thereof, and the overlying blocking layer 22 has the second opening 220 filled with the defining member 310. The second opening 220 may have an upper surface at a same level with that of the defining member 310.

In the fabrication method of the light receiving stacked-hole structure of the present embodiment, the defining member 310 is formed by using the base light blocking layer 21 as a mask plate, and the overlying light blocking layer 22 is formed by using the defining member 310 as the boundary thereof, that is, each light blocking portion of the overlying light blocking layer 22 is defined by the defining member 310. Therefore, it can be ensured that the formed overlying light blocking layer 22 is aligned with the base light blocking layer 21 without misalignment, and the light receiving hole formed by the first opening 210 and the second opening 220 coinciding with each other can form a normal light path therein. The light receiving stacked-hole structure fabricated by the method can perform normal fingerprint recognition when being used in a fingerprint recognition device.

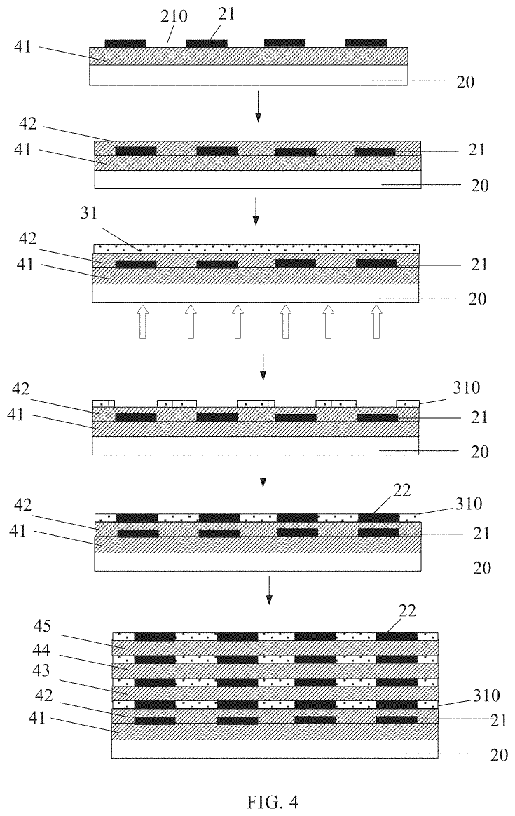

Another embodiment of the present disclosure provides a fabrication method of a light receiving stacked-hole structure, as shown in FIG. 4, including the following steps S01a to S03:

Step S01a includes forming a transparent material layer 41 on a first surface of a substrate 20. The material of the transparent material layer 41 may include at least one of polyimide, over coat (OC) material, high transparent resin material, and transparent post spacer (PS) material. As an example, the transparent material layer 41 may be a polyimide layer. In this case, a polyimide prepolymer solution may be coated on the substrate 20, and then be cured under high temperature or light irradiation to obtain the polyimide layer with a certain thickness.

Description is given below by taking the polyimide layer as a transparent material layer.

Step S01b includes forming a base light blocking layer 21 having first openings 210 on a first polyimide layer 41. The material for forming the base light blocking layer 21 may be the same as that of a black matrix as long as the material has light blocking properties. In an embodiment, a light blocking material layer may be formed firstly, and then be patterned by etching process to obtain the base light blocking layer 21 having the first openings 210.

Optionally, step S02 includes forming a transparent second polyimide layer 42 on the substrate 20 subjected to the previous step (i.e., on a side of the first polyimide layer 41 away from the substrate 20 and a side of the base blocking layer 21 away from the substrate 20). The specific fabrication method in this step is similar to that in step S01a, which will not be described repeatedly herein.

Alternatively, step S02 may include filling the first opening 210 of the base blocking layer 21 with a defining member 310, and then forming a transparent second polyimide layer 42 on the side of the base blocking layer 21 away from the substrate 20 and a side of the defining members 310 away from the substrate 20.

Step S03 includes forming a overlying blocking layer 22 having second openings 220 on the second polyimide layer 42 such that orthographic projections of the second openings 220 on the substrate 20 coincide with orthographic projections of the first openings 210 on the substrate 20 and the first openings 210 and the second openings 220 form the light receiving holes.

As a specific implementation of the present embodiment, step S03 of forming the stacked light blocking layer 22 having the second openings 220 includes step S03a to step S03c.

Step S03a includes forming a light-transmissive defining layer 31 on a side of the second polyimide layer 42 away from the substrate 20. In the embodiment, the specific material of the defining layer 31 is not limited as long as it can allow light to transmit therethrough. As a specific implementation, the material of the defining layer 31 may be the same as that of the pixel defining layer (PDL), such as an organic polymer material including silicon and/or fluorine.

Step S03b includes patterning the defining layer 31 using the base light blocking layer 21 as a mask plate to obtain a plurality of defining members 310.

In an embodiment, in the process of patterning the defining layer 31 using the base light blocking layer 21 as the mask plate to obtain the plurality of defining members 310, light enters from a second surface of the substrate 20 opposite to the first surface to expose the defining layer 31 and therefore the defining layer 31 is patterned to form the plurality defining members 310.

In an embodiment, a crosslinking reaction occurs to the exposed portion of the defining layer 31 to become an insoluble matter, and the non-exposed portion of the defining layer 31 is dissolved by a developing solution, so that the obtained pattern (that is, the defining members 310) is complementary with the pattern of the mask plate (that is, the pattern of the base light blocking layer 21). Accordingly, the orthographic projections of the plurality of defining members 310 on the substrate 20 coincide with the orthographic projections of the first openings 210 on the substrate 20.

In this step, the fabrication of a metal alignment mask plate can be omitted by using the base light blocking layer 21 as a mask plate, which results in reduced number of times of the mask process. In addition, by using back exposure, the alignment accuracy of an ashing process can be increased and the alignment accuracy of the openings of the stacked plurality of light blocking layers can be improved.

Step S03c includes forming the overlying blocking layer 22 by using the defining members 310 as boundaries thereof. The overlying blocking layer 22 has the second openings 220 filled with the defining members 310.

In an embodiment, the method further includes step S04a of sequentially forming, on the substrate 20 subjected to the previous steps (i.e., on sides of the defining members 310 and the overlying light blocking layer 22 away from the substrate 20), a transparent third polyimide layer 43, the defining members 310, the overlying light blocking layer 22, a transparent fourth polyimide layer 44, the defining members 310, the overlying blocking layer 22, a transparent fifth polyimide layer 45, the defining members 310 and the overlying light blocking layer 22 according to steps S02, S03a, S03b, and S03c in the method. In this way, the light receiving stacked-hole structure shown in FIG. 6 or light receiving stacked-hole structure shown in FIG. 7 can be formed.

In the fabrication method of the light receiving stacked-hole structure in the present embodiment, the plurality of overlying blocking layers 22 are each formed by using the base light blocking layer 21 as a mask plate, which results in omission of the fabrication of a metal alignment mask plate. In addition, by using back exposure, the alignment accuracy of an asking process can be increased and misalignment is unlikely to occur. The alignment accuracy of the light receiving stacked-hole structure formed by the base light blocking layer 21 and the plurality of overlying light blocking layers 22 is relatively high.

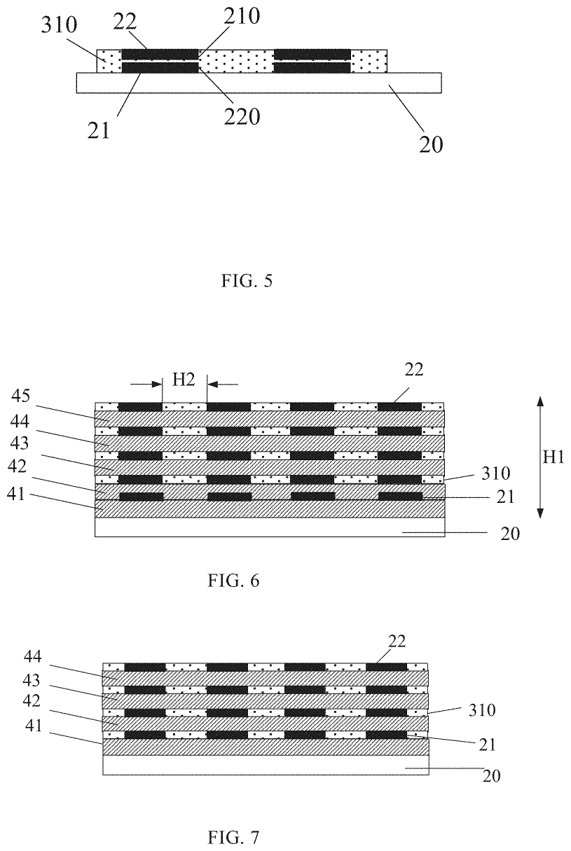

An embodiment of the present disclosure provides a light receiving stacked-hole structure, as shown in FIG. 5, including a substrate 20 and a base light blocking layer 21 disposed on a first surface of the substrate 20. The base light blocking layer 21 has first openings 210. The light receiving stacked-hole structure further includes at least one overlying light blocking layer 22 disposed on a side of the base light blocking layer 21 away from the substrate 20. The overlying light blocking layer 22 has second openings 220 filed with light-transmissive defining members 310. The defining members 310 are formed by using the base light blocking layer 21 as a mask plate, such that the orthographic projections of the second openings 220 on the substrate 20 coincide with the orthographic projections of the first openings 210 on the substrate 20, and the first openings 210 and the second openings 220 form the light receiving holes.

In the light receiving stacked-hole structure of the present embodiment, the defining members 310 are formed by using the base light blocking layer 21 as a mask plate, and the overlying light blocking layer 22 is formed by using the defining members 310 as boundaries thereof, that is, the light blocking portions of the overlying light blocking layer 22 are defined by the defining members 310. Therefore, it can be ensured that the overlying light blocking layer 22 formed subsequently is aligned with the base light blocking layer 21 without misalignment, and the light receiving holes formed by the first openings 210 and the second openings 220 coinciding with one another can form normal light paths therein.

As an optional implementation of the present embodiment, the light receiving stacked-hole structure includes a plurality of overlying light blocking layers 22, and a transparent polyimide layer is disposed between adjacent two overlying light blocking layers 22.

As an optional implementation of the present embodiment, a transparent polyimide layer is disposed between the overlying light blocking layer 22 and the base light blocking layer 21.

As an optional implementation of the present embodiment, a transparent polyimide layer is disposed between the substrate 20 and the base light blocking layer 21.

The polyimide layer in the present embodiment functions to increase the thickness of the light receiving stacked-hole structure. Accordingly, the plurality of polyimide layers disposed spaced apart from each other function to reduce the number of the overlying light blocking layers. The specific number of the polyimide layers and the thickness of each of the polyimide layers are not limited herein, which can be adjusted and changed according to actual needs.

In an embodiment, the defining members 310 are made of a transparent organic material.

The specific material of the defining members 310 is not limited in the present embodiment as long as it can allow light to transmit therethrough. In a specific application, the material of the defining members 310 may be the same as that of the pixel defining layer (PDL), and may be, for example, an organic polymer material including silicon and/or fluorine.

In an embodiment, the light receiving stacked-hole structure has a size of about 70 μm to about 120 μm in a direction perpendicular to the first surface of the substrate 20, and each of the polyimide layers has a thickness of about 15 μm to about 35 μm.

In an embodiment, as shown in FIG. 6, the first polyimide layer 41, the base light blocking layer 21, the second polyimide layer 42 (the second polyimide layer 42 is further provided in the first openings 210 of the base light blocking layer 21), the defining members 310 and the overlying light blocking layer 22 in a same layer, the third polyimide layer 43, the defining members 310 and the overlying light blocking layer 22 in a same layer, the fourth polyimide layer 44, the defining members 310 and the overlying light blocking layer 22 in a same layer, the fifth polyimide layer 45, and the defining members 310 and the overlying light blocking layer 22 in a same layer are sequentially disposed on the substrate 20. Here, “in a same layer” may mean “at a same level”. The light receiving stacked-hole structure has a size H1 of about 70 μm in the direction perpendicular to the first surface of the substrate 20, and has a aperture H2 of about 10 μm (that is, the first opening 210 and the second opening 220 has a aperture H2 of about 10 μm), and each hole formed by the first opening 210 and the second openings 220 stacked on one another allows only light having an angle of less than 8.5° to pass therethrough, that is, the angle between the direction perpendicular to the first surface of the substrate 20 and a direction along which the light which is allowed to pass the light receiving stacked-hole structure is transmitted is less than 8.5°.

In another specific embodiment, as shown in FIG. 7, the first polyimide layer 41, the base light blocking layer 21 and the defining members 310 in a same layer, the second polyimide layer 42, the defining members 310 and the overlying light blocking layer 22 in a same layer, the third polyimide layer 43, the defining members 310 and the overlying light blocking layer 22 in a same layer, the fourth polyimide layer 44, and the defining members 310 and the overlying light blocking layer 22 in a same layer are sequentially disposed on the substrate 20.

Other transparent materials such as an over coat material, a high transparent resin material, a transparent post spacer material, or the like may be adopted in place of polyimide to form the transparent material layer according to an embodiment of the present disclosure.

In the drawings corresponding to the present embodiment, the size, thickness, or the like of the respective structural layers shown in the drawings are merely illustrative. In the process implementation, the projections of respective structural layers on the substrate may have a same area or different areas. The required area of the projection of each structural layer may be achieved by an etching process. Meanwhile, the structures shown in the drawings are not limited to have the geometric shapes shown in the drawings, and for example, may have a rectangle shape as shown in the drawings, or may have a trapezoidal shape, or other shapes formed by other etching processes.

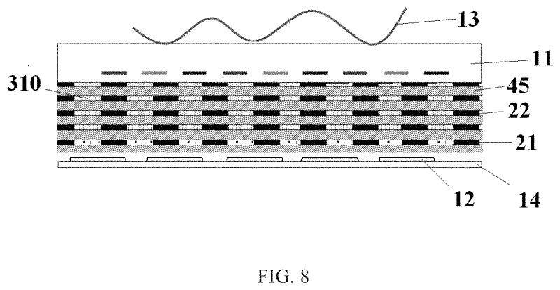

An embodiment provides a fingerprint recognition device, as shown in FIG. 8, including a touch substrate 11, a back plate 14 having a plurality of sensors 12 for fingerprint recognition, and the above light receiving stacked-hole structure disposed between the touch substrate 11 and the back plate 14. According to an embodiment of the present disclosure, the sensors 12 may be located between the light receiving stacked-hole structure and the back plate 14.

The light receiving stacked-hole structure and the back plate 14 having the sensors 12 for fingerprint recognition may share s same substrate.

An embodiment provides a touch device which includes the fingerprint recognition device according to an embodiment of the present disclosure. The touch device may be any product or component having a display function, such as a liquid crystal display panel, an electronic paper, an OLED panel, a mobile phone, a tablet computer, a television, a display, a notebook computer, a digital photo frame, a navigator, and the like.

It can be understood that the above embodiments are merely exemplary embodiments used for illustrating the principle of the present disclosure, but the present disclosure is not limited thereto. For those skilled in the art, various modifications and improvements may be made without departing from the spirit and essence of the present disclosure, and these variations and improvements are also considered to be within the protection scope of the present disclosure.

1. A fabrication method of a light receiving stacked-hole structure, comprising:
forming a base light blocking layer having a first opening on a first surface of a substrate; and
forming at least one overlying light blocking layer having a second opening on a side of the base light blocking layer away from the substrate,
wherein forming the overlying light blocking layer having the second opening comprises:
forming a light-transmissive defining layer on the side of the base light blocking layer away from the substrate and the first surface of the substrate;
patterning the defining layer by using the base light blocking layer as a mask plate to obtain a defining member, an orthographic projection of the defining member on the substrate coinciding with an orthographic projection of the first opening on the substrate; and
forming the overlying light blocking layer by using the defining member as a boundary thereof, the second opening of the overlying light blocking layer being filled with the defining member.

2. The method of claim 1, wherein in patterning the defining layer by using the base light blocking layer as a mask plate to obtain the defining member, the defining layer is exposed by light entering from a second surface of the substrate opposite to the first surface.

3. The method of claim 1, wherein the method comprises forming a plurality of the overlying light blocking layers having the second openings;
and further comprises forming a transparent material layer between forming adjacent two overlying light blocking layers having the second openings.

4. The method of claim 1, further comprising forming a transparent material layer between forming the base blocking layer having the first opening and forming the overlying light blocking layer having the second opening.

5. The method of claim 4, further comprising filling the first opening with the defining member between forming the base blocking layer having the first opening and forming the transparent material layer.

6. The method of claim 1, further comprising forming a transparent material layer on the first surface of the substrate before forming the base blocking layer having the first opening, and the base blocking layer having the first opening is formed on a side of the transparent material layer away from the substrate.

7. The method of claim 3, wherein the transparent material layer comprises at least one of polyimide, over coat material, high transparent resin material, and transparent post spacer material.

8. A light receiving stacked-hole structure comprising:
a substrate;
a base light blocking layer disposed on a first surface of the substrate and having a first opening;
at least one overlying light blocking layer disposed on a side of the base light blocking layer away from the substrate and having a second opening filed with a light-transmissive defining member,
wherein the defining member is formed by using the base light blocking layer as a mask plate, and an orthographic projection of the defining member on the substrate coincides with an orthographic projection of the first opening on the substrate.

9. The structure of claim 8, further comprising:
a transparent material layer disposed between the overlying light blocking layer and the base light blocking layer and in the first opening of the base light blocking layer.

10. The structure of claim 8, further comprising:
a transparent material layer disposed between the overlying light blocking layer and the base light blocking layer, and the first opening of the base light blocking layer is filled with the light-transmissive defining member.

11. The structure of claim 8, further comprising:
a transparent material layer disposed between the substrate and the base light blocking layer.

12. The structure of claim 8, wherein the light receiving stacked-hole structure comprises a plurality of the overlying light blocking layers, and a transparent material layer is disposed between adjacent two overlying light blocking layers.

13. The structure of claim 12, wherein the light receiving stacked-hole structure has a size of about 70 μm to about 120 μm in a direction perpendicular to the first surface of the substrate, and each transparent material layer has a thickness of about 15 μm to about 35 μm.

14. The structure of claim 8, wherein the defining member is made of a transparent organic material.

15. The structure of claim 9, wherein the transparent material layer comprises at least one of polyimide, over coat material, high transparent resin material, and transparent post spacer material.

16. A fingerprint recognition device, comprising:
a touch substrate, a back plate having a plurality of fingerprint recognition sensors, and a light receiving stacked-hole structure disposed between the touch substrate and the back plate, wherein the light receiving stacked-hole structure is the light receiving stacked-hole structure of claim 8.
